(19) United States
(12) Patent Application Publication
(10) Pub. No.: US 2024/0303597 A1
(43) Pub. Date: Sep. 12, 2024

(54) AUTOMATED LOGISTICS TRANSSHIPMENT MANAGEMENT SYSTEM

(71) Applicants: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-Sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/118,731

(22) Filed: Mar. 7, 2023

(51) Int. Cl. G06Q 10/0875

(52) U.S. Cl. CPC G06Q 10/0875

(57) ABSTRACT

An automated logistics transshipment management system is provided. The automated logistics transshipment management system includes a shipper module, a shipping information module, a transshipment processing module, a customs declaration module and a bill of lading module and a customer module.

### BACKGROUND OF THE INVENTION

### 1. Field of the Invention

The present disclosure relates to a technical field of international cargo transportation, and more particularly to an automated logistics transshipment management system applied to customers.

### 2. Descriptions of Related Art

Maritime transport, also known as international ocean cargo transportation, is the most important transportation in international logistics. It refers to a way to transport goods via waterways between ports in different countries and regions and is currently the most widely used method in international cargo transportation.

However, the application level of the existing international freight forwarding logistics industry is generally low. For shipping agents, some are basically using EXCEL, WORD, and other software for manual recording. This manual record management is not only a heavy workload but also has poor standardization and is easy to cause confusion in management. Many departments are involved in the shipping logistics business, and it is often necessary to file and receive information to/from banks, customs, border management, government inspection and quarantine departments, and insurance companies. Further, the information is highly repetitive, which seriously delays the operation efficiency.

Moreover, the current manual document management method makes it difficult to carry out effective tracking, early warning, and goods statistics. Not only that, this manual document management method has low flexibility and poor stability, and it is difficult to expand and modify functions according to the development of the ship logistics industry. It cannot flexibly manage and change projects. The current management method of manual document records is mainly based on paper documents for information storage, which is not convenient for data sharing, and it is difficult to meet the needs of real-time query, and it is difficult to track and query each business in real-time.

In addition, the known methods of shipping logistics agencies are mostly using paper, email, telephone, SMS, etc., to complete the export-related ship booking and customs declaration operations. For example, the shipping company sends the booking information to the freight forwarding company using paper mail, mail, telephone, SMS, etc. The freight forwarding company then sends the ordering information back to the customer through paper mail, mail, telephone, SMS, etc., and asks the customer to send back the additional information required by the shipping company and customs. After receiving the information, the freight forwarding company sends the information to the shipping company or customs by paper mail, mail, telephone, SMS, etc., to complete the export-related paperwork. Afterward, the freight forwarding company arranges the truck to pick up and deliver the goods by email, telephone, SMS, etc. This method of operation is not only inefficient, time-consuming, and labor-intensive but also seriously affects the efficiency of data processing and transfer.

### SUMMARY OF THE INVENTION

The present disclosure provides an automated logistics transshipment management system. The system can accurately match the corresponding transshipment port and shipping schedule according to the requirements of the shipper, and automatically generate the corresponding customs declaration and bill of lading, so that the current progress of cargo delivery can be checked at any time to achieve real-time tracking and digitization purpose.

In order to achieve the objective mentioned above, the present disclosure provides an automated logistics transshipment management system, including a shipper module, a shipping information module, a transshipment processing module, a customer module, a customs declaration module, and a bill of lading module. The shipper module generates a cargo shipping information. The shipping information module receives the cargo shipping information from the shipper module and generates at least one cargo information module. The transshipment processing module receives the at least one cargo information module of the shipment information module. The transshipment processing module includes a checking module and an international cargo contract generating module, the checking module is used to check the information of the cargo information module, and the international cargo contract generating module is used to generate an international cargo contract information after the checking module checking all the information of the shipping information module.

Further, after the execution of the checking module and the international cargo contract generating module is completed, the transshipment processing module generates a customs declaration module and a bill of lading module. The customer module receives a document information of the customs declaration module and a bill of lading information of the bill of lading module, and displays all the conditions and progress of the cargo during the shipping and transshipment process.

### BRIEF DESCRIPTION OF THE DRAWINGS

The described embodiments may be better understood by reference to the following description and the accompanying drawings in which:

FIG. 1 is a schematic view of modules of the automated logistics transshipment management system of the present disclosure.

FIG. 2 is a schematic view of a shipping information module of the automated logistics transshipment management system of the present disclosure.

FIG. 3 is a schematic view of a transshipment processing module of the automated logistics transshipment management system of the present disclosure.

FIG. 4 is a schematic view of a customs declaration module of the automated logistics transshipment management system of the present disclosure.

### DETAILED DESCRIPTION OF THE PREFERRED EMBODIMENTS

The present disclosure is more particularly described in the drawings and following examples that are intended as illustrative only. It is to be understood that these embodiments are exemplary implementations and are not to be construed as limiting the scope of the present disclosure in any way. Further modifications to the disclosed embodiments, as well as other embodiments, are also included within the scope of the appended claims. Regarding the drawings, the relative proportions and ratios of elements in the drawings may be exaggerated or diminished in size for the sake of clarity and convenience. Such arbitrary proportions are only illustrative and not limiting to the scale.

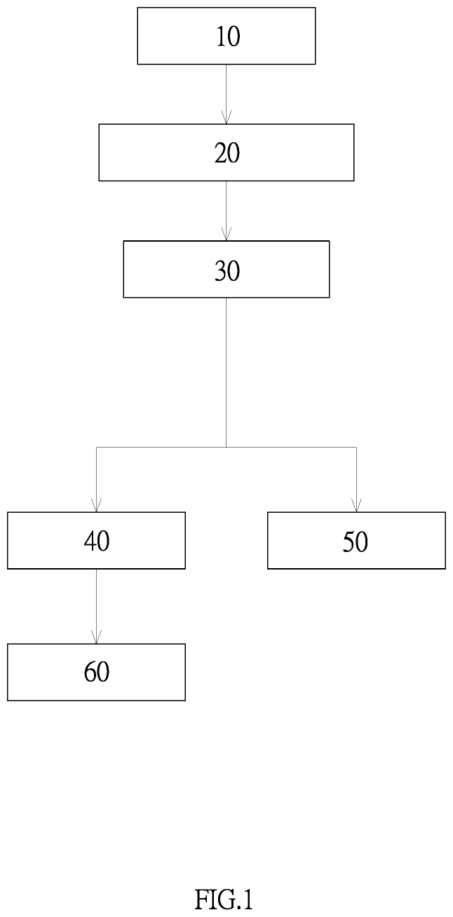

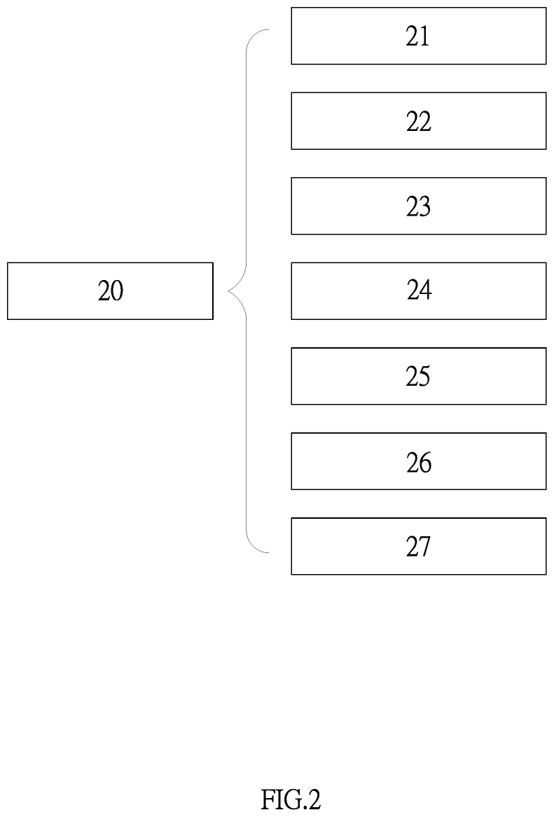

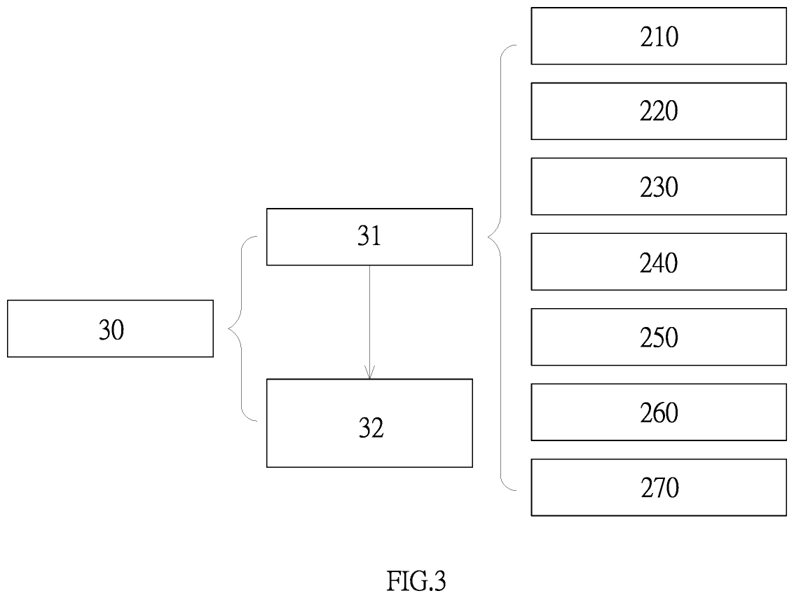

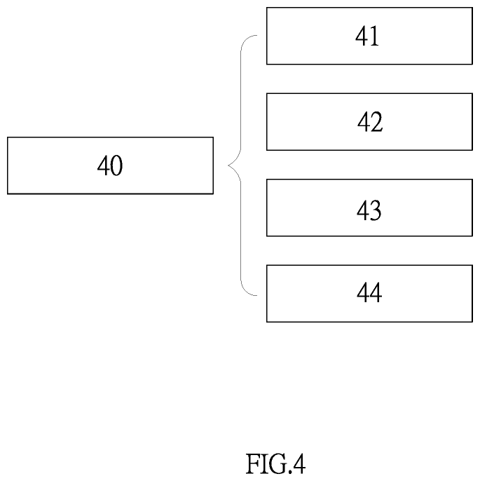

Referring to FIGS. 1-4, the present disclosure provides an automated logistics transshipment management system for customers to check the current progress of cargo delivery at any time. The automated logistics transshipment management system includes a shipper module 10, a shipping information module 20, a transshipment processing module 30, a customs declaration module 40, a bill of lading module 50, and a customer module 60.

In detail, the shipper module 10 generates a cargo shipping information. The cargo shipping information can be a departure information, a transshipment port information and an arrival information.

The shipping information module 20 receives the cargo shipping information from the shipper module 10 and generates at least one cargo information module according to the cargo shipping information. The at least one cargo information module can be: a bill of lading number generating module 21, a number module 22, a weight module 23, a voyage No. module 24, a shipment date module 25, an arrival date module 26, and a cargo arrival module 27.

The bill of lading number generating module 21 is used to generate a suitable bill of lading number information according to the contents of the goods combined with the voyage routes, shipping schedules, and cabins. The bill of lading number information includes a bill of lading main number and a bill of lading semicolon. Each good with export authority will have a bill of lading number, usually a tax invoice number, for financial review and settlement.

The number module 22 is used to generate a total number of goods information 220 according to the number of pieces of consignment.

The weight module 23 is used to generate a total weight information 230 according to the weight of the consignment. The voyage No. module 24 is used to generate a voyage No. information 240 about the export of voyages. The shipment date module 25 is used to generate a shipping date information 250 according to the shipping schedule. The arrival date module 26 is used to generate an arrival date information 260 according to the shipping schedule. The cargo arrival module 27 is used to generate a cargo arrival information 270 according to notifying the consignee when the ship arrives at the port.

The transshipment processing module 30 is used to receive the at least one cargo information module of the shipment information module 20. The transshipment processing module 30 includes a checking module 31 and an international cargo contract generating module 32. The checking module 31 is used to check the bill of lading number information 210 of the bill of lading number generating module 21, the total number of goods information 220 of the number module, the total weight information 230 of the weight module 23, the voyage No. information 240 of the voyage No. module 24, the shipping date information 250 of the shipment date module 25, the arrival date information 260 of the arrival date module 26 and cargo arrival information 270 of the cargo arrival module 27. The international cargo contract generating module 32 generates an international cargo contract information after the checking module checking all the information of the shipping information module 20. Specifically, the international cargo contract refers to an agreement contract in which one party provides goods and transfers ownership, and the other party pays the price. Further, after the checking module 31 and the international cargo contract generating module 32 of the transshipment processing module 30 is operated and completed, a customs declaration module 40 and a bill of lading module 50 are generated.

In detail, the customs declaration module 40 is used to provide the information of a paper document issued to the import and export departments after the customs accepts the import and export declaration, indicating the quantity, the total transaction price, and stamping the verification stamp. The customs declaration module 40 includes a departure port information 41, a destination port information 42, an approval information 43, and a trade information 44.

The departure port information 41 is used to display departure port name and departure port code.
the destination port information 42 is used to display destination port name and destination port code.
the approval information 43 is used to display approval number.
the trade information 44 is used to display code according to actual trade classification of goods.

The bill of lading module 50 generates a bill of lading information corresponding to each information in the customs declaration module 40. The customer module 60 receives a document information of the customs declaration module 40 and a bill of lading information of the bill of lading module 50 and displays all the conditions and progress of the cargo during the shipping and transshipment process.

In conclusion, the automated logistics transshipment management system of the present disclosure includes a shipper module 10, a shipping information module 20, a transshipment processing module 30, a customs declaration module 40, a bill of lading module 50 and a customer module 60.

Through the intelligent modules combination that can automatically generate various cargo transshipment information, the customer and the shipping agency can check the progress of the current cargo delivery through this system at any time, so as to achieve real-time tracking and digitization of delivery information.

It can be seen that the automated logistics transshipment management system of the present disclosure has indeed improved the conventional international freight forwarding operation process and overcome the disadvantage of using paper mail, e-mail, telephone, and SMS, and complicated process with repeatedly transmitting, collecting, and confirming.

What is claimed is:

1. An automated logistics transshipment management system, comprising:
a shipper module, generating a cargo shipping information;
a shipping information module, receiving the cargo shipping information from the shipper module and generating at least one cargo information module;
a transshipment processing module, receiving the at least one cargo information module of the shipment information module; wherein the transshipment processing module includes a checking module and an international cargo contract generating module, the checking module is used to check the information of the cargo information module, and the international cargo contract generating module is used to generate an international cargo contract information after the checking module checking all the information of the shipping information module;
wherein, after the execution of the checking module and the international cargo contract generating module is completed, the transshipment processing module generates a customs declaration module and a bill of lading module; and
a customer module, receiving a document information of the customs declaration module and a bill of lading information of the bill of lading module, and displaying all the conditions and progress of the cargo during the shipping and transshipment process.

2. The automated logistics transshipment management system according to claim 1, the at least one cargo information module includes a bill of lading number generating module, a number module, a weight module, a voyage No. module, a shipment date module, an arrival date module and a cargo arrival module.

3. The automated logistics transshipment management system according to claim 2, wherein the bill of lading number generating module is used to generate a bill of lading number information according to the contents of the goods, voyage routes and shipping schedules; the number module is used to generate a total number of goods information according to the number of pieces of consignment; the weight module is used to generate a total weight information according to the weight of the consignment; the voyage No. module is used to generate a voyage No. information about the export of voyages; the shipment date module used to generate a shipping date information according to the shipping schedule; and the arrival date module is used to generate an arrival date information according to the shipping schedule.

4. The automated logistics transshipment management system according to claim 1, the customs declaration module includes a departure port information, a destination port information, an approval information and a trade information.

5. The automated logistics transshipment management system according to claim 4, wherein the departure port information is used to display departure port name and departure port code, the destination port information is used to display destination port name and destination port code, the approval information is used to display approval number, and the trade information is used to display code according to actual trade classification of goods.

6. The automated logistics transshipment management system according to claim 1, wherein the cargo shipping information is a departure information.

7. The automated logistics transshipment management system according to claim 1, wherein the cargo shipping information is a transshipment port Information.

8. The automated logistics transshipment management system according to claim 1, wherein the cargo shipping information is an arrival information.

9. The automated logistics transshipment management system according to claim 3, wherein the bill of lading number information includes a bill of lading main number and a bill of lading semicolon.
